(19) United States
(12) Patent Application Publication
(10) Pub. No.: US 2017/0333272 A1
(43) Pub. Date: Nov. 23, 2017

(54) Bed System Having Removable Bed Pan

(71) Applicant: Dianna Foster, Pontiac, MI (US)

(72) Inventor: Dianna Foster, Pontiac, MI (US)

(21) Appl. No.: 15/596,241

(22) Filed: May 16, 2017

Related U.S. Application Data
(60) Provisional application No. 62/338,007, filed on May 18, 2016.

(51) Int. Cl. A61G 7/02; A61G 9/00

(52) U.S. Cl. CPC A61G 7/02; A61G 9/003

(57) ABSTRACT

A bed system. The bed system including a mattress, and a frame having a channel extends horizontally from a first side to a point between the first side and a second side. The channel comprising a track configured to receive a bed pan. The mattress having an aperture positioned vertically over the channel.

### CROSS REFERENCE TO RELATED APPLICATIONS

This application claims the benefit of U.S. Provisional Application No. 62/338,007 filed on May 18, 2016. The above identified patent application is herein incorporated by reference in its entirety to provide continuity of disclosure.

### BACKGROUND OF THE INVENTION

The present invention relates to bed systems.

The sick and the elderly are sometimes bedridden, incontinent, or otherwise incapable of normal use of rest room facilities. In such cases where possible medical staff assist in the otherwise normal use of a rest room, some patients are required to use a bed pan or a diaper. Either option can have inconvenient, embarrassing, and injurious psychological effects.

Diapers can cause rashes and sores if worn for too long a period of time. A bed pan is typically used by having medical personnel place the bed pan between the patient and the bed. The patient may then either recall the medical personnel to remove the bed pan immediately after use or in some situations may be forced to remain with the bed pan for a prolonged period while awaiting the return of the medical personnel. If a patient has difficult moving on their own, has seizures or is unconscious, there may be unfortunate spillage unto the bed. This would force medical personnel to bathe the patient, replacing the bed linens, and returning the patient to the bed. This process is difficult physically and psychologically for both the patient and the medical personnel. Therefore, it is desirable to have a device by which a patient may relieve themselves independently, without assistance, and without the risk of spills.

### SUMMARY OF THE INVENTION

In view of the foregoing disadvantages inherent in the known types of bed systems now present in the known art, the present invention provides a frame comprising a first frame sidewall and an opposing second frame sidewall. The first frame sidewall further comprising a channel with a distal end and an open end disposed along the first frame sidewall. The channel extends from the first frame sidewall toward the second frame sidewall. The channel comprising a track configured to slidably receive a bed pan. A mattress comprising an upper surface and an aperture configured such that when placed upon the frame the aperture is in vertical alignment over the channel wherein the same can be utilized for providing convenience for the user when the user needs to relieve themselves.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the bed system.

FIG. 2 shows a perspective view of the frame of an embodiment of the bed system.

FIG. 3 shows a perspective view of an embodiment of the bed system with an embodiment of the plug being inserted therein.

FIG. 4 shows a perspective view of an embodiment of the bed system with an embodiment of the insert being inserted therein.

FIG. 5 shows a perspective view of an embodiment of the bed system with an embodiment of the guard being inserted therein.

FIG. 6 shows a perspective view of an embodiment of the bed system with an alternate embodiment of the guard being inserted therein.

### DETAILED DESCRIPTION OF THE INVENTION

Reference is made herein to the attached drawings. Like reference numerals are used throughout the drawings to depict like or similar elements of the bed pan receiving bed. The figures are intended for representative purposes only and should not be considered to be limiting in any respect. Unless specifically limited to a single unit, “a” is intended to be equivalent to “one or more” throughout the present disclosure.

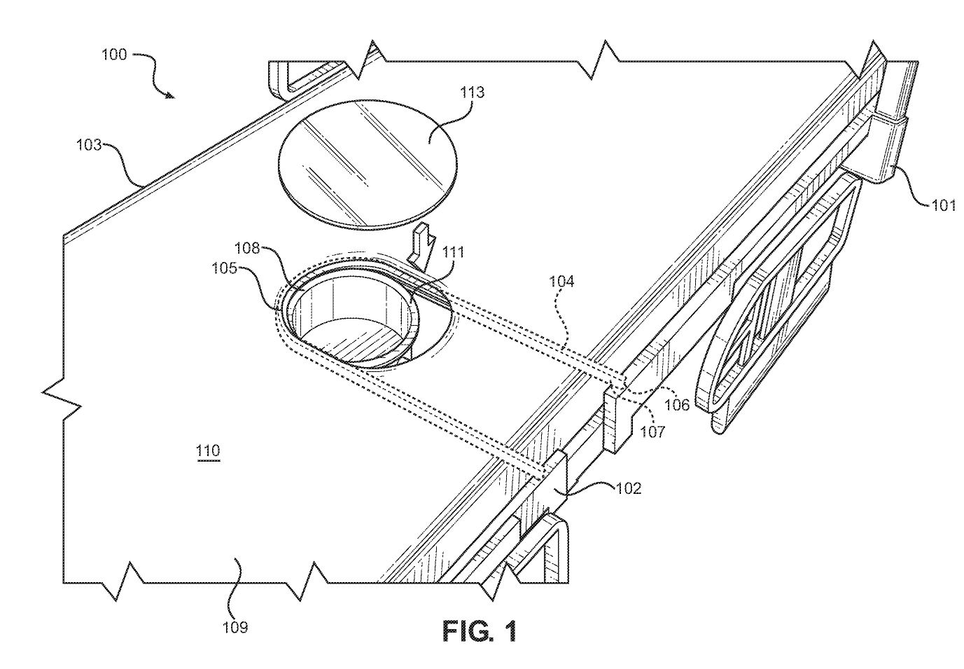

Referring now to FIG. 1, there is shown a perspective view of an embodiment of the bed system. The bed system 100 comprises a frame 101 having a first frame sidewall 102 and an opposing second frame sidewall 103. The first frame sidewall 102 further comprises a channel 104 with a distal end 105 and an open end 106 disposed along the first frame sidewall 102. The channel 104 extends from the first frame sidewall 102 towards the second frame sidewall 103. In the shown embodiment, the channel 104 has a track 107 configured to slidably receive a bed pan 108. The bed system 100 further comprises a mattress 109 having an upper surface 110 and an aperture 111 configured such that when placed upon the frame 101 between the sidewalls 102, 103, the aperture 111 is in vertical alignment over the channel 104. A cover 113 is adapted to be placed over the bed pan 108 when the bed pan 108 is not in use.

The channel 104 extends in a U-shape but in other embodiments is shaped differently such as a rectangle. The channel has a distal end 105 configured in this embodiment to be in vertical alignment below the aperture 111. However, in other embodiments the channel 104 and thereby the distal end 105 are extended further, in some embodiments abutting the second frame sidewall 103. In some embodiments, the cover 113 is placed atop the bed pan 108 when the bed pan 108 is not in use. In other embodiments, the cover 113 is placed atop the distal end 105 and in yet other embodiments is place atop a portion of the channel 104.

The mattress 109 has a filling configured to support a person in a comfortable manner. Embodiments of the mattress 109 use foam, pocketed coil springs, and gel as well as other suitable types of filling known to a person of ordinary skill in the art. While in the shown embodiment the aperture 111 is in vertical alignment over the distal end 105 other embodiments place the aperture 111 in vertical alignment over other portions of the channel 104. Embodiments of the upper surface 110 are made of fabric, vinyl, and other suitable materials known to persons of ordinary skill in the art.

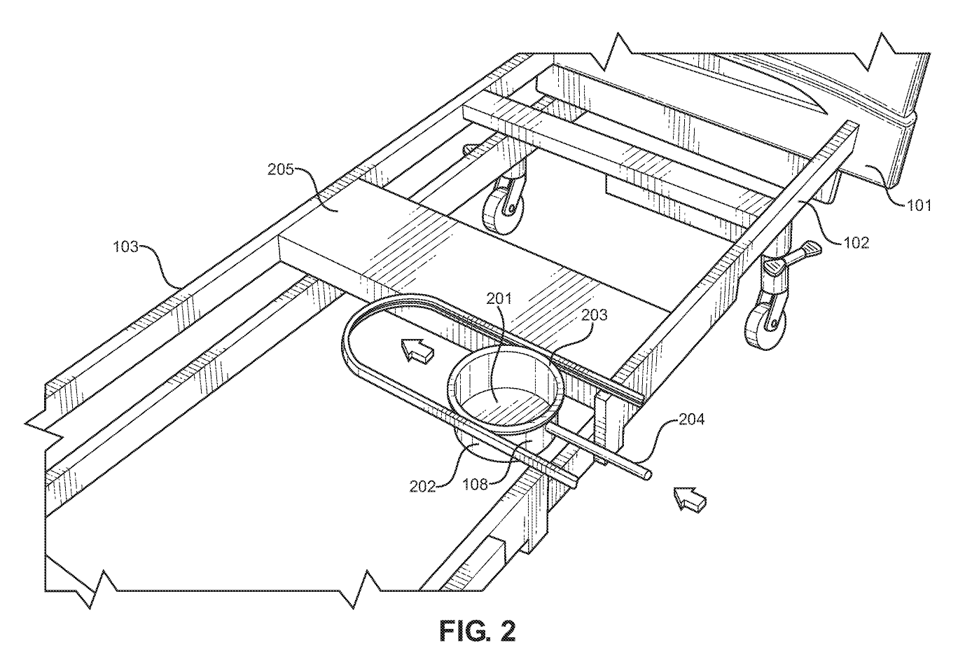

Referring now to FIG. 2, there is shown a perspective view of the frame of an embodiment of the bed system. The bed pan 108 has a base 201 with a sidewall 202 along the perimeter of the base 201 extending upwards therefrom forming an interior volume with an open upper end. The sidewall 202 has a flange 203 and a handle 204 affixed to the sidewall 202. Some embodiments of the bed pan 108 do not have a handle 204. The bed pan 108 is slidably received by the track and the flange 203 rests upon the track. The flange 203 in some embodiments is configured to act as a seat.

In the illustrated embodiment, the frame 101 is a rectangular metal bed on wheels with adjustable side rails. The frame 101 has a horizontal slat 205 extending from the first frame sidewall 102 to the second frame sidewall 103 configured to support the mattress 109 thereon. In the illustrated embodiment, the horizontal slat 205 is a planar member, however, in other embodiments the horizontal slat 205 is tubular. In yet other embodiment the horizontal slat 205 is other suitable shapes known to persons of ordinary skill in the art. In some embodiments, the frame 101 is a power frame capable of raising and lowering portions of the frame 101. Other embodiments of the frame 101 use other suitable shapes, materials and modifications known to persons of ordinary skill in the art such as vibration motors.

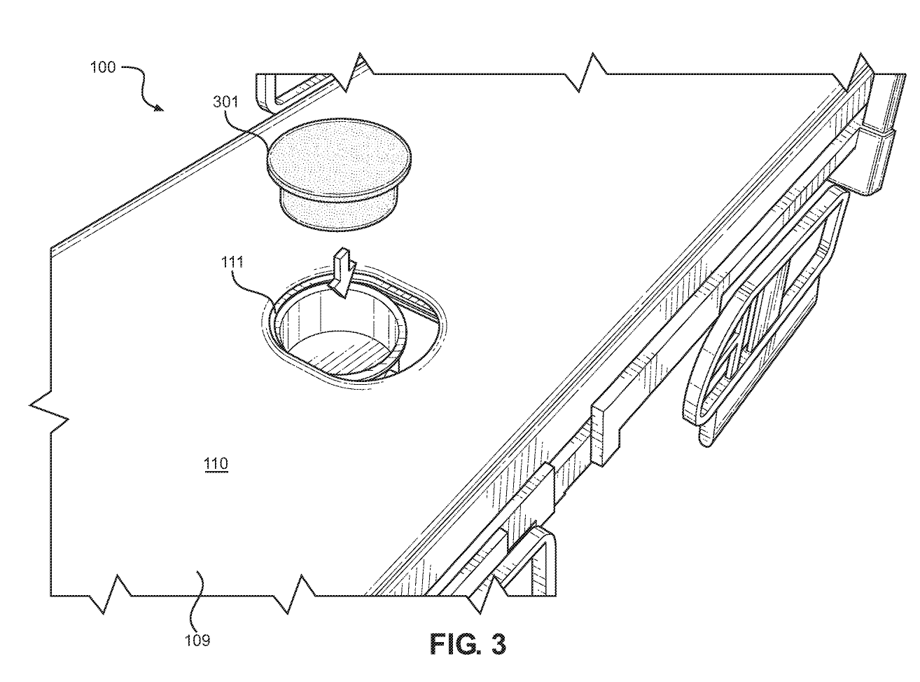

Referring now to FIG. 3, there is shown a perspective view of an embodiment of the bed system with an embodiment of the plug being inserted therein. A plug 301 is dimensioned to fill the aperture 111 such that the plug 301 is flush with the upper surface 110. The plug 301 is configured to support a person in conjunction with the mattress 109. The plug 301 has the same filling and upper surface 110 material as the mattress 109 in some embodiments. The plug 301 when inserted into the aperture 111 rests upon the cover in some embodiments. In other embodiments, the plug 301 rests upon the channel and in yet other embodiments the plug 301 rests upon the bed pan.

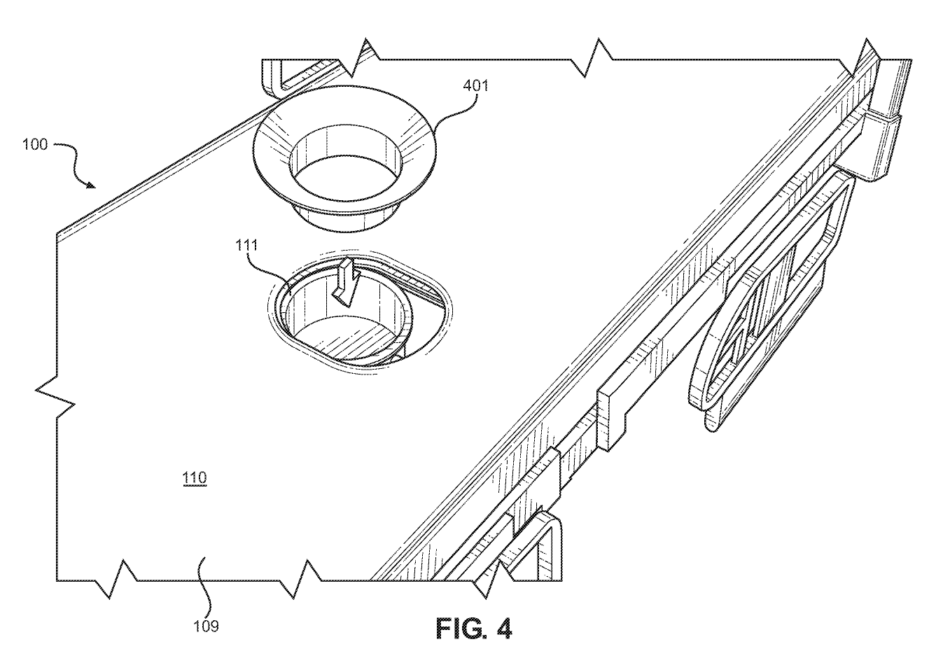

Referring now to FIG. 4, there is shown a perspective view of an embodiment of the bed system with an embodiment of the insert being inserted therein. The waterproof insert 401 is removably affixable to the aperture 111 and has an open upper end and an open lower end. The insert 401 is configured to line the aperture 111. In some embodiments, the insert 401 is a flexible plastic funnel. In other embodiments, the insert 401 is a rigid plastic cylinder with a flange. In yet other embodiments, other suitable shapes and materials known to persons of ordinary skill in the art is used.

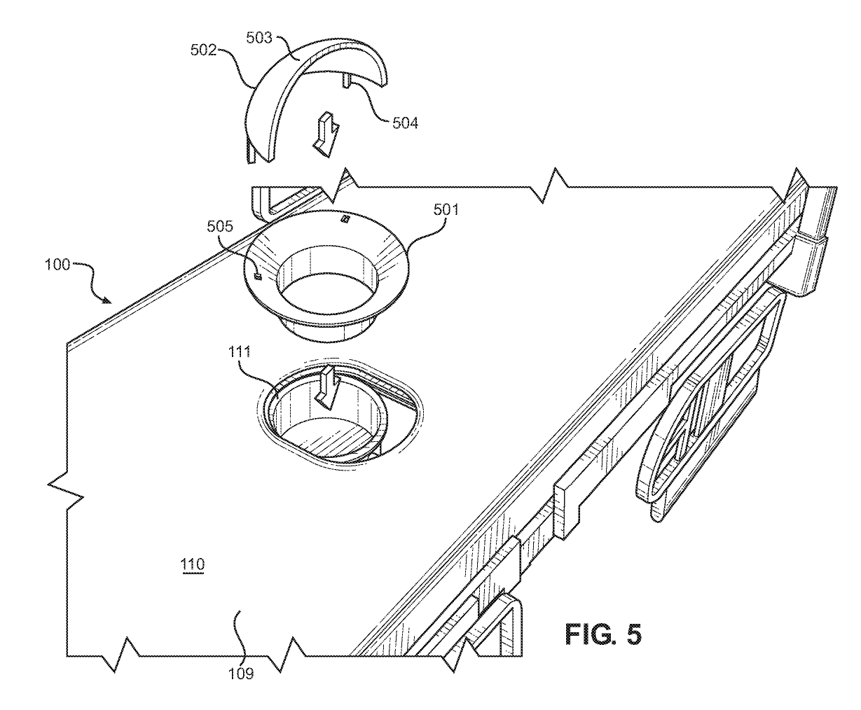

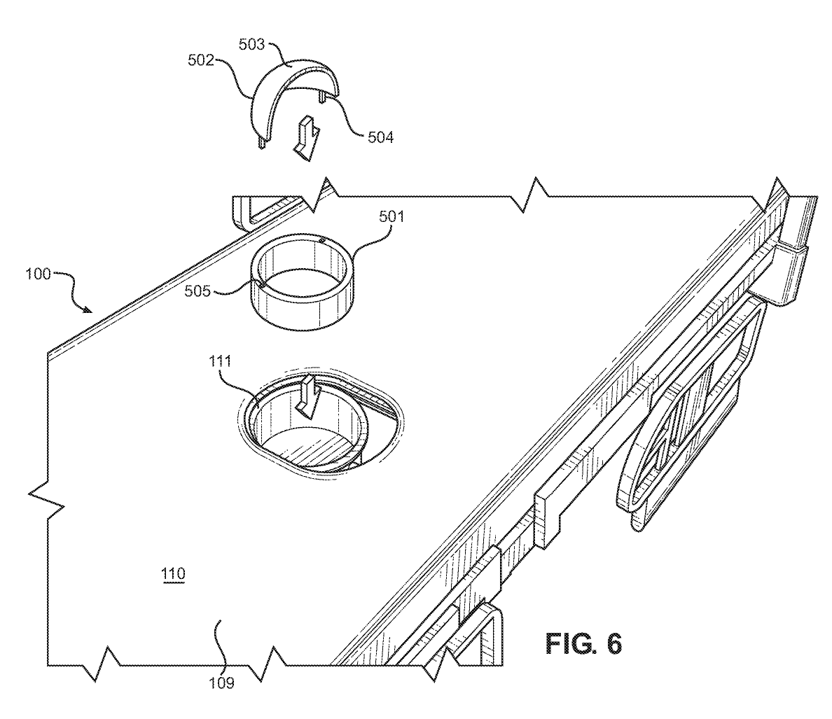

Referring now to FIGS. 5 and 6, there is shown a perspective view of the guard inserted into the bed system, and a perspective view of an embodiment of the bed system with an alternate embodiment of the guard being inserted therein, respectively. The guard 502 comprising a rigid curved member 503 removably affixable to the insert 501. In embodiments with the guard 502 the insert 501 is made of a rigid material. The insert 501 has an aperture 505 configured to receive a protrusion 504 of the member 503. The guard 502 is adapted to accommodate men by directing urination into the bed pan. In the illustrated embodiment, the member 503 is shaped as a half dome, however, in other embodiments other suitable shapes known to persons of ordinary skill in the art are used such as conical and polyhedral shapes.

In use the bed system is adapted to allow a bed ridden person to normally rest upon the bed, but when needed use the aperture and bed to relieve themselves without embarrassment or outside assistance. In embodiments with a plug and insert, a bed ridden person lays normally upon the plug without need to avoid the aperture or feel discomfort at its presence and as needed remove the plug and place the insert into the aperture. Male patients also at this time use the guard.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bed system, comprising:
a frame comprising a first frame sidewall and an opposing second frame sidewall;
the first frame sidewall further comprising a channel with a distal end and an open end disposed along the first frame sidewall;
the channel extends from the first frame sidewall toward the second frame sidewall;
the channel comprising a track configured to slidably receive a bed pan; and
a mattress comprising an aperture configured such that the aperture is in vertical alignment over the channel when placed upon the frame.

2) The bed system of claim 1, wherein:
the aperture is in vertical alignment over the distal end.

3) The bed system of claim 1, wherein:
the frame has a horizontal slat extending from the first frame sidewall to the second frame sidewall configured to support the mattress thereon.

4) The bed system of claim 1, wherein:
a waterproof insert removably affixable to the aperture;
the insert configured to line the aperture.

5) The bed system of claim 4, wherein:
the insert is configured such that the insert is covering an upper surface of the mattress surrounding the aperture.

6) The bed system of claim 4, further comprising:
a guard removably affixable to the insert.

7) The bed system of claim 1, further comprising:
a plug configured to be received by the aperture, wherein the plug is flush with an upper surface of the mattress.

8) The bed system of claim 1, wherein:
the channel is U-shaped such that distal end of the channel corresponds with the bend in the U shape.

9) The bed system of claim 1, wherein:
the bed pan comprises a base with a sidewall along the perimeter of the base, the bed pan configured for sliding engagement with the track.

10) The bed system of claim 9, wherein:
the sidewall of the bed pan extends upwards from the perimeter of the base forming an interior volume with an open upper end;
the sidewall further comprising a flange.

11) The bed system of claim 9, further comprising:
a handle affixed to the sidewall of the bed pan.
